(19) United States
(12) Patent Application Publication
(10) Pub. No.: US 2006/0277776 A1
(43) Pub. Date: Dec. 14, 2006

(54) Multipurpose construction gauge

(76) Inventor: Lawrence J. Paul, Knapp, WI (US)

Correspondence Address: Felix J. Sahlin, 1480 Mississippi River Boulevard South, St. Paul, MN, 55116-1853, US

(21) Appl. No.: 11/013,569

(22) Filed: Dec. 15, 2004

(51) Int. Cl. B43L 7/027

(52) U.S. Cl. 33/474

(57) ABSTRACT

A multipurpose construction gauge to ensure installation of pre hung windows and doors within their mounting frame openings in a plumb, square and level manner with the inner sill gapped flush with later installed sheet rock. Other applications include masonry.

### CROSS REFERENCE TO RELATED APPLICATIONS

N/A

### STATEMENT CONCERNING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of Invention

The present invention relates to a multipurpose gauge for use in construction applications.

2. Background of the Invention

### SUMMARY OF THE INVENTION

It is an object of this invention to ensure installation of pre hung windows and doors within their mounting frame openings in a plumb, square and level manner with the inner sill gapped flush with inner wall sheet rock assuring level, plumb, square and accurate sill or frame gapping. Other applications include masonry and plumbing.

The various features of novelty which characterize the invention are pointed out with particularity in the claims annexed to and forming a part of this disclosure. For a better understanding of the invention, its advantages and objects, reference is made to the accompanying drawings and descriptive matter in which the preferred embodiment of the invention is illustrated.

### BRIEF DESCRIPTION OF THE DRAWINGS

FIG. 1 is a view demonstrating of an embodiment of the invention. The indicia “a” illustrates the thickness of the edge of the multipurpose gauge is equal. This measurement is equal to the thickness of the commercially manufactured sheetrock to be attached around the installed window or door frame;

FIG. 2 is a view of preferred embodiment of the invention as set out in Claim 1. The thickness of the edge of the multipurpose gauge is equal. This measurement is equal to the thickness of the commercially manufactured sheetrock to be attached around the installed window or door frame. Means for determining level imbedded in the first arm and a means for determining plumb imbedded in the second arm, in this illustration a typical bubble in liquid.

FIG. 3 is a view of Claim 5 wherein the means for determining plumb and a means for determining level are imbedded in the first as well as the second arms of the gauge. This allows verification of either plumb or square regardless of the relative 90° orientation of the gauge.

FIG. 4 is a view of claim 6 wherein the means for determining level or plumb imbedded in either arm of the gauge may be rotated and secured at 90° in orientation relative to said arm to indicate level or plumb when said multipurpose gauge is employed in an alternate perpendicular orientation.

FIG. 5 is a view of the features set out in Claim 2. The blown up portion illustrates the use of markings to indicate the thickness of thinner sizes of sheet rock in this case lines imprinted parallel to the horizontal edges of the inner vertical faces of the multipurpose gauge. The thickness of the gauge is of a dimension equal to that of the thickest commercially available sheetrock.

FIG. 6 illustrates the embodiment set out in claim 4. In this embodiment, the thickness of the gauge is of a dimension equal to that of the thickest commercially available sheetrock. The thickness references for smaller sizes of sheet rock on the inner vertical face of the gauge are indicated by color coded bands with a different color to indicate each thicknesses.

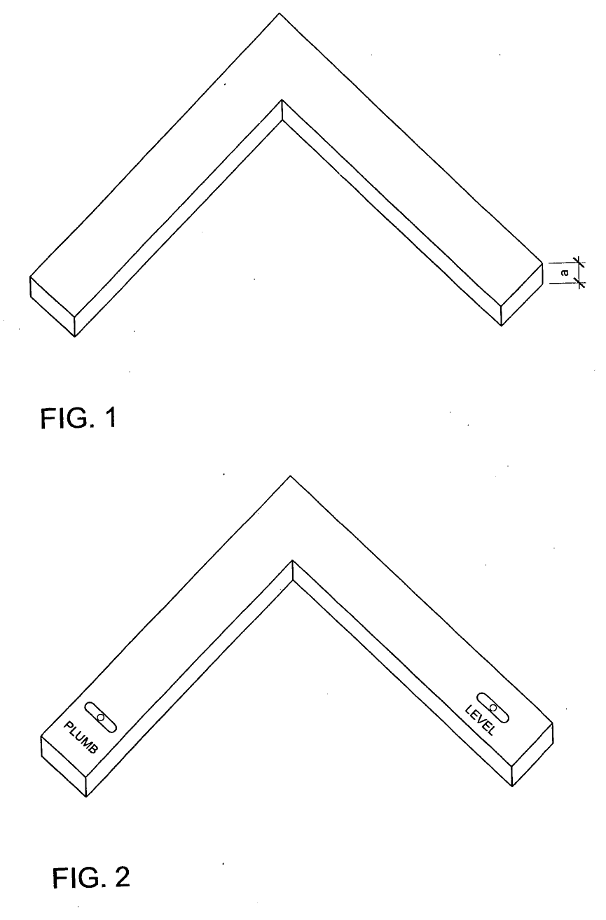

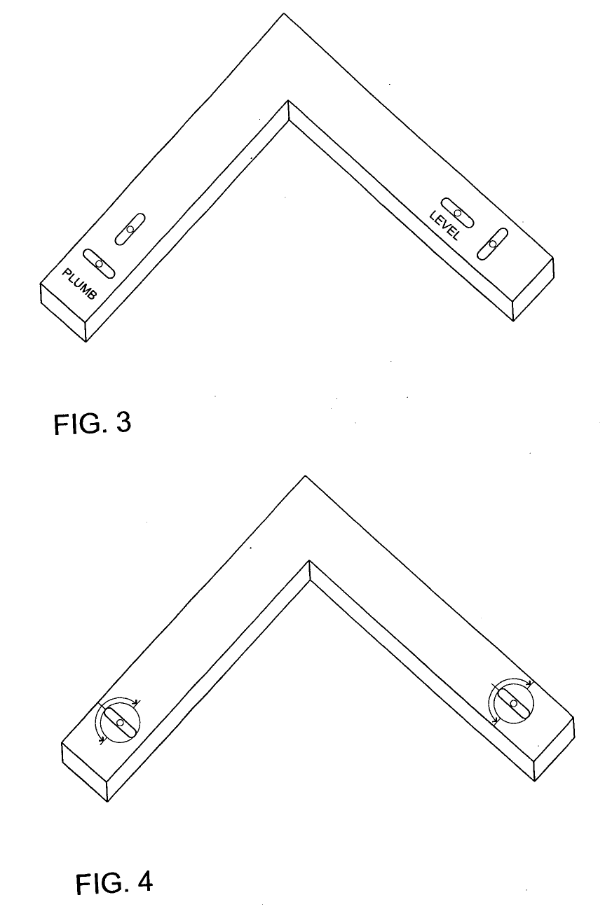

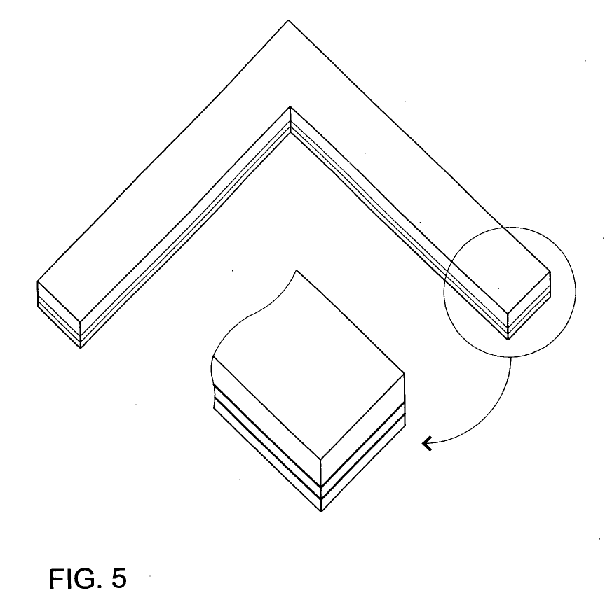

### DESCRIPTION OF THE PREFERRED EMBODIMENT OF THE INVENTION

The workmanlike installation of pre hung window requires that the unit be oriented so that the window heads and sills (frame top and bottom holding the window glass) are level and the jambs (vertical frame members holding the window glass) are plumb within it's surrounding mounting opening. In addition, the inner sill must be positioned in such a manner that the sill's intrusion past the interior plane of the mounting opening is the same distance as the thickness of the sheetrock which will later be attached to the wall(s) surrounding the installed window. Proper installation of framed doors requires essentially the same procedure.

In the United States, sheetrock is currently manufactured in standard thicknesses of ⅜, ½ and ⅝ths of an inch respectively. Sheetrock is also manufactured in metric thickness for example within the European Union.

The laying of masonry, whether in the form of cement blocks or bricks also requires constant verification of level, plumb and square as each block or brick is laid in rows or courses. The present invention allows the user to verify level plumb and proper gapping of the interior window sill in one operation using one device or gauge.

It is an object of this invention to ensure installation of pre hung windows and doors within their mounting frame openings in a plumb, square and level manner with the proper gapping of the sills and frames to permit sheet rock to be attached around the frame so that the edge of sheet rock will be flush with the face of the respective frame. The invention may also be used in masonry applications to continuously verify that bricks or cement blocks are level along the current course, plumb with the preceding course and flush with respect to each adjoining block or brick during their erection.

In the preferred embodiment, the invention comprises a gauge in the form of a framing square comprising two arms with flat, parallel sides oriented at a 90° to each other. The thickness of the gauge is equal to the thickness of the sheet rock to be applied to the surfaces surrounding the window unit. Means for determining and indicating level or plumb are incorporated into each arm of the gauge. The means for indicating level or plumb may comprise a bubble, plumb line or gauge, protracting device indicating a discrete angle, laser or any other method of measuring and indicating a 90 or 180 degree angle in any plane. Alternatively, for indicating level and plumb may be embedded into both arms.

Optionally, the gauge incorporates a means for rotating the position of the means for indicating level or plumb embedded in both arms to an alternate, 90 degree position. This allows use of the means for indicating level or plumb to be adjusted to indicate either condition in any alternate 90° orientation.

The thicknesses edge of the gauge may be made in a dimension equal to the thickness of the sheetrock to be installed. The thickness of the edge may also be greater than the thickness of the sheetrock to be installed, up to a dimension equal to that of the thickest commercially available sheetrock. In this mode a system of markings indicating the thickness of various thinner sizes of sheetrock is employed. The various sheet rock thicknesses may be indicated by inscription of lines equal to the thickness of various sizes of sheet rock, parallel to the horizontal edges of the face of the gauge when the gauge is laid flat. Alternatively the various thicknesses may be indicated by lines printed in the edge of the gauge or employing color coded bands to indicate the relative thicknesses.

Other embodiments are within the following claims.

I claim:

1. A multipurpose gauge for construction applications comprising:
a. a carpenter's square having a first and second leg at right angles to each other wherein the thickness of the edge of the multipurpose gauge is equal to the thickness of the commercially manufactured sheetrock to be attached around the installed window or door frame;
b. a means for determining level imbedded in the first arm and a means for determining plumb imbedded in the second arm.

2. A multipurpose gauge for construction applications comprising:
a. a carpenter's square having a first and second leg at right angles to each other wherein the thickness of the edge of the multipurpose gauge is equal to or greater than the thickness of the sheetrock to be installed, said edge incorporating markings parallel to the horizontal edge of the inner vertical faces of the gauge when the multipurpose gauge is laid flat to indicate the thickness of thinner sizes of sheetrock;
b. means for determining level imbedded in the first arm and means for determining plumb imbedded in the second arm.

3. A multipurpose gauge of claim 2 wherein the thickness references of smaller sizes of sheet rock are indicated by color coded bands with a different color to indicate each thicknesses.

4. A multipurpose gauge as described in any as described in any of the previous claims in which means for determining plumb and a means for determining level are imbedded in the first as well as the second arms of said multipurpose gauge.

5. A multipurpose gauge of claims 1,2,3 or 4 in which a means for determining level or plumb imbedded in either arm of said multipurpose gauge may be rotated and secured at 90° in orientation relative to said arm to indicate level or plumb when said multipurpose gauge is employed in an alternate perpendicular orientation.
